(19) United States
(12) Patent Application Publication
(10) Pub. No.: US 2006/0203466 A1
(43) Pub. Date: Sep. 14, 2006

(54) Light emitting panel and backlight system having the same and liquid crystal display device having the backlight system

(75) Inventors: Ji-whan Noh, Suwon-si (KR); Il-yong Jung, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS, CO., LTD.

(21) Appl. No.: 11/360,523

(22) Filed: Feb. 24, 2006

(30) Foreign Application Priority Data
Mar. 11, 2005 (KR) 10-2005-0020576

(51) Int. Cl. G01D 11/28

(52) U.S. Cl. 362/29; 362/97; 362/240; 362/243

(57) ABSTRACT

A light emitting panel, a backlight system having the same, and a liquid crystal display (LCD) device having the backlight system. The light emitting panel includes: a bottom surface from which incident light is reflected; at least one protrusion that has a side surface and protrudes from the bottom surface; and a plurality of light emitting diodes (LEDs) that are installed in a row in a lengthwise direction on the side surface of the protrusion and obliquely angled with respect to the bottom surface.

### CROSS-REFERENCE TO RELATED PATENT APPLICATIONS

This application claims the benefit of Korean Patent Application No. 10-2005-0020576, filed on Mar. 11, 2005, in the Korean Intellectual Property Office, the disclosure of which is incorporated herein in its entirety by reference.

### BACKGROUND OF THE INVENTION

1. Field of the Invention

Apparatuses consistent with the present invention relate to a light emitting panel in which a plurality of light emitting diodes (LEDs) are disposed in a plurality of lines, and a backlight system having the same, and a liquid crystal display (LCD) device having the backlight system.

2. Description of the Related Art

Liquid crystal display (LCD) devices, which are a type of flat panel displays, are light receiving type displays that are not self-luminescent, but form an image using incident light from the outside. Backlight systems are installed on a rear side of the LCD device and radiate light onto a liquid crystal panel.

Backlight systems can be mainly classified into direct light emitting type backlight systems that radiate light emitted from a plurality of light sources directly installed under an LCD device onto a liquid crystal panel, and edge light emitting type backlight systems that transmit light emitted from a light source installed at sidewalls of a light guide panel (LGP) onto the liquid crystal panel, according to the arrangement of a light source.

In the direct light emitting type backlight systems, a light emitting diode (LED) that emits Lambertian light can be used as a point source of light. In addition, LEDs are arranged in a two-dimensional array, for example, in a plurality of lines, with a plurality of LEDs in each line.

When light emitted from an LED is diffused by a diffusion plate and radiated onto a liquid crystal panel, in order to make color light emitted from the LED unnoticeable over the diffusion plate, the light emitted from the LED should travel slightly to the side and be incident on the diffusion plate.

U.S. Pat. No. 6,679,621 discloses a side emitting LED. Since the conventional side emitting LED of U.S. Pat. No. 6,679,621 uses a side emitting device 1 shown in FIG. 1, Lambertian light emitted from an LED chip (not shown) having a predetermined area can travel sideways. Referring to FIG. 1, in the conventional side emitting LED, the side emitting device 1 includes a funnel-shaped reflecting surface 3 obliquely angled with respect to a central axis c′ of the side emitting device 1, a first refracting surface 5 obliquely angled with respect to the central axis c′ of the side emitting device 1 to refract incident light reflected from the reflecting surface 3, and a convex shaped second refracting surface 7 extending from a bottom surface 9 to the first refracting surface 5.

Light incident on the side emitting device 1 from an LED (not shown) and traveling toward the reflecting surface 3 is reflected from the reflecting surface 3 toward the first refracting surface 5, is transmitted through the first refracting surface 5, and travels substantially sideways. In addition, light incident into the side emitting device 1 from the LED (not shown) and then incident on the convex second refracting surface 7 is transmitted through the second refracting surface 7 and travels substantially sideways.

In the conventional side emitting LED, the light emitted from the LED chip travels sideways so that an array of the side emitting LEDs can be used in a direct light emitting type backlight system.

However, since the size of the conventional side emitting device 1 is large, when the conventional side emitting LED is used as a point light source, a distance between side emitting LEDs placed on each line should be large so that light emitted from the side emitting LEDs can be fully spread. For example, when the LED chip emits Lambertian light in a 1 mm×1 mm area, the distance between the side emitting LEDs should be at least 10 mm, for example.

Due to the large distance between the side emitting LEDs, the thickness of the backlight system must be increased. This is because, as the distance between LEDs increases, a mixing distance required for obtaining uniform white light also increases.

### SUMMARY OF THE INVENTION

Exemplary embodiments of the present invention provide a light emitting panel in which a plurality of light emitting diodes (LEDs) are densely arranged and light generated by the LEDs is mixed, a backlight system having a sufficiently small thickness by using the light emitting panel, and a liquid crystal display (LCD) device having the backlight system.

According to an aspect of the present invention, there is provided a light emitting panel, the light emitting panel including: a bottom surface from which incident light is reflected; at least one protrusion that has a side surface and protrudes from the bottom surface in a line shape; and a plurality of light emitting diodes (LEDs) that are installed in a row in a lengthwise direction on the side surface of the protrusion and obliquely angled with respect to the bottom surface.

The side surface may be obliquely angled with respect to the bottom surface. The LEDs may be installed on the side surfaces to be obliquely angled with respect to the bottom surface. The side surface may include a planer region including a portion where the LEDs are arranged, and a curved region adjacent to the bottom surface. The side surface may be a reflecting surface.

The light emitting panel may further include a plurality of protrusions to form a plurality of lines, and an arrangement formed by the plurality of LEDs may be disposed on each side surface of the plurality of protrusions. At least one of the side surface of the protrusion and the bottom surface may be coated for reflection. The arrangement formed by the plurality of LEDs may be disposed on both side surfaces of each of the protrusions.

According to another aspect of the present invention, there is provided a backlight system, the backlight system including: a light emitting panel; and a first transmission diffusion plate disposed above the light emitting panel to diffuse and transmit incident light from the light emitting panel.

The backlight system may further include at least one of a brightness enhancement film for enhancing directivity of light emitted from the first transmission diffusion plate and a polarization enhancement film for enhancing polarization efficiency.

According to another aspect of the present invention, there is provided a liquid crystal display (LCD) device, the LCD device including: a liquid crystal panel; and a backlight system radiating light onto the liquid crystal panel.

The light emitting panel may be formed so that the protrusion and the arrangement formed by the plurality of the LEDs make a predetermined angle with respect to a direction perpendicular to the direction of gravity.

### BRIEF DESCRIPTION OF THE DRAWINGS

The above and other aspects of the present invention will become more apparent by describing in detail exemplary embodiments thereof with reference to the attached drawings, in which:

FIG. 1 is a cross-sectional view of a conventional side emitting light emitting diode (LED) disclosed in U.S. Pat. No. 6,679,621;

FIG. 2 is a schematic perspective view of a light emitting panel according to an exemplary embodiment of the present invention;

FIG. 3 is an enlarged view of a portion of the light emitting panel illustrated in FIG. 2;

FIG. 4 is a cross-sectional view of the light emitting panel illustrated in FIG. 2;

FIG. 5 shows an example of an LED used in the light emitting panel illustrated in FIG. 2;

FIG. 6 illustrates ray tracing when an LED is obliquely angled with respect to the side surfaces of a protrusion of the light emitting panel illustrated in FIG. 2;

FIG. 7 illustrates simplified ray tracing shown in FIG. 6;

FIG. 8 is a perspective view of an arrangement of conventional side emitting LEDs disposed on a plate to form seven lines;

FIG. 9 shows optical simulation results of a distribution of light intensity obtained from the arrangement of FIG. 8;

FIG. 10 shows optical simulation results of a distribution of light intensity obtained from the light emitting panel illustrated in FIGS. 2 through 4, 6, and 7;

FIG. 11 shows optical simulation results of a distribution of light intensity, when LEDs are disposed to be obliquely angled on the side surface of a protrusion having a flat region extending to a bottom surface without a curved region;

FIG. 12 shows optical simulation results of a distribution of light intensity, when the LEDs are disposed to be obliquely angled on the side surface of the protrusion having a planar region and a curved region;

FIG. 13 is a schematic cross-sectional view of a backlight system having the light emitting panel of FIG. 2 according to an exemplary embodiment of the present invention; and

FIG. 14 is a schematic view of a liquid crystal display (LCD) device having the backlight system of FIG. 13.

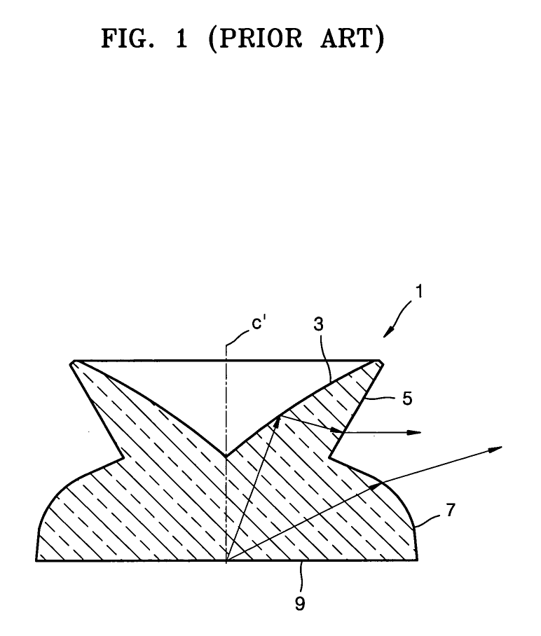

### DETAILED DESCRIPTION OF EXEMPLARY EMBODIMENTS OF THE INVENTION

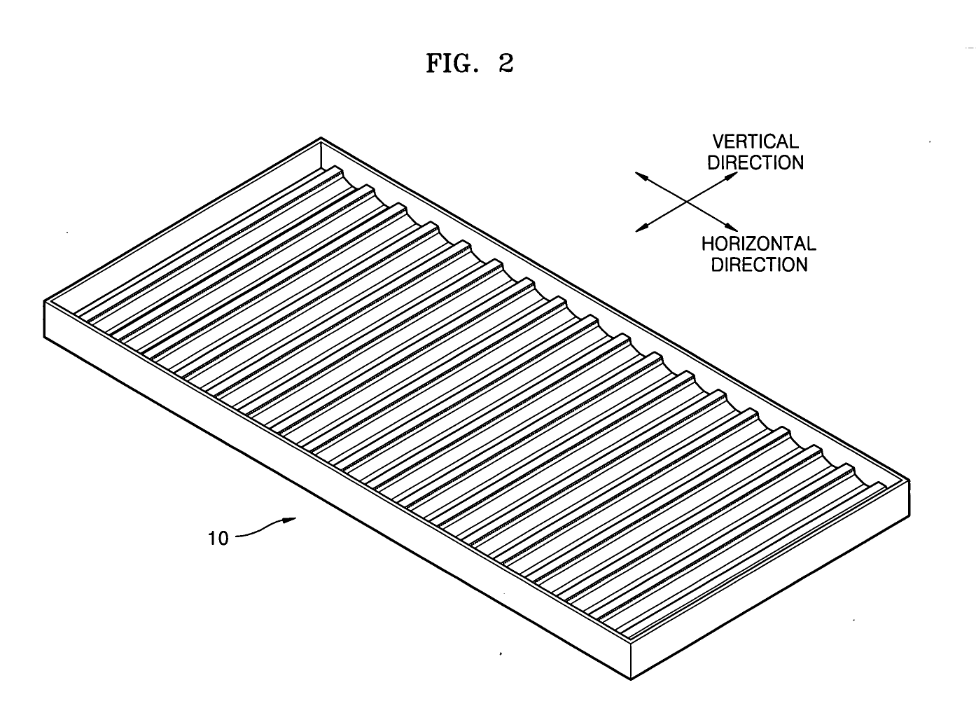

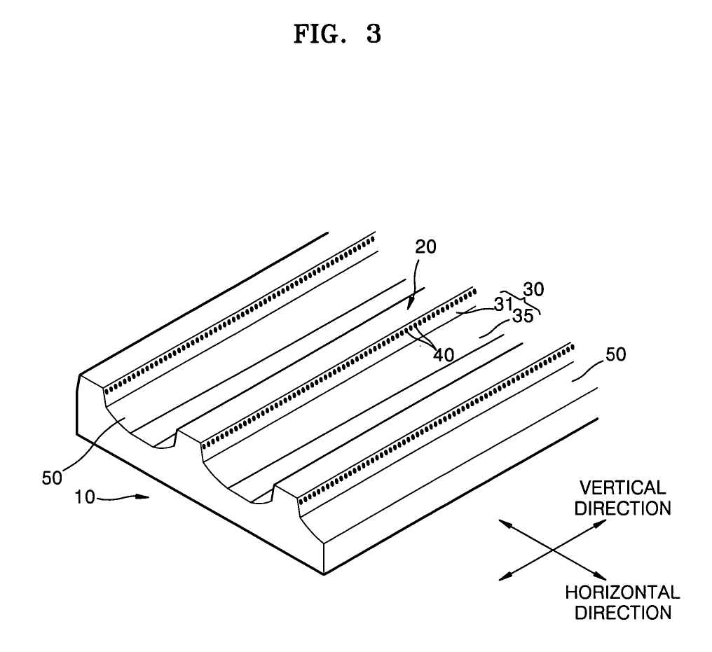

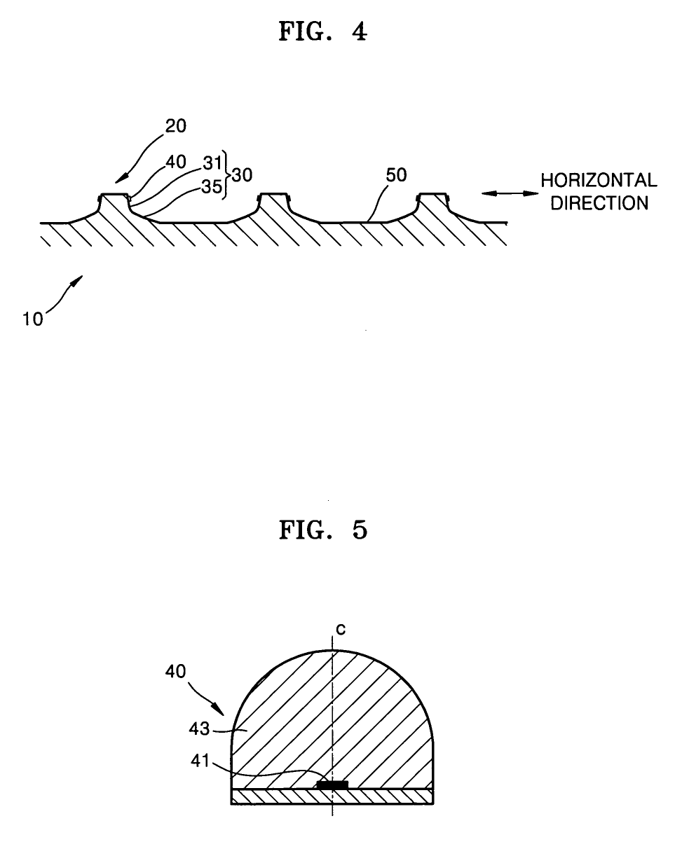

FIG. 2 is a schematic perspective view of a light emitting panel 10 according to an exemplary embodiment of the present invention, FIG. 3 is an enlarged view of a portion of the light emitting panel 10 illustrated in FIG. 2, and FIG. 4 is a cross-sectional view of the light emitting panel 10 illustrated in FIG. 2.

Referring to FIGS. 2 through 4, the light emitting panel 10 includes a bottom surface 50 on which incident light is reflected, at least one protrusion 20 protruding from the bottom surface 50 in a line shape and having side surfaces 30, and a plurality of light emitting diodes (LEDs) 40 installed on the side surfaces 30 of the protrusion 20 to be obliquely angled with respect to the bottom surface 50 and to be arranged in a lengthwise direction along the protrusion 20.

A plurality of the protrusions 20 may be provided to form a plurality of lines. In this case, the bottom surface 50 exists between the protrusions 20. The bottom surface 50 reflects incident light.

The side surfaces 30 may be formed to be outwardly and obliquely angled so that the distance between lower portions of the adjacent protrusions 20 is smaller than the distance between upper portions of the protrusions 20. In this case, the LEDs 40 may be slightly obliquely angled upward with respect to the bottom surface 50 when they are installed on the side surfaces 30 of the protrusion 20. With the additional use of a separate mount (not shown), the inclination of LEDs 40 can be changed to have a desired angle.

The side surfaces 30 may be overall reflecting surfaces. Alternatively, the side surfaces 30 may be only formed as a non-reflecting surface in a region where the LEDs 40 are arranged.

The side surfaces 30 may be overall reflecting surfaces including a planar region 31 in which the LEDs 40 are arranged, and a curved region 35 adjacent to the bottom surface 50.

The side surfaces 30 of the protrusion 20 and the bottom surface 50 may be coated with a reflective material to reflect incident light.

The LEDs 40 are installed on at least one side surface 30 of the protrusion 20 to form a row. Alternatively, as illustrated in FIGS. 2 and 3, the LEDs 40 may be disposed on both side surfaces 30 of the protrusions 20. In this case, if the number of the protrusions 20 is n, the LEDs 40 form 2n lines.

In order to provide a white light source, the arrangement of the LEDs 40 in lines may be formed in such a manner that the LEDs 40 emitting different colors of light such as R, G, and B are regularly and alternately arranged.

In the light emitting panel 10, since the LEDs 40 are arranged in lines, the LEDs 40 can be sufficiently densely arranged. For example, when the LEDs 40 emit Lambertian light in a 1 mm×1 mm area, the LEDs 40 can be separated by a smaller distance than 1 mm if necessary, or at any greater desired distance.

In this way, since the LEDs 40 can be organized as densely as a user wants, a mixing distance required for obtaining a uniform distribution of light can be reduced so that when the light emitting panel 10 is applied to a backlight system, the backlight system can have a sufficiently small thickness.

FIG. 5 shows an example of the LED 40 applicable to FIGS. 2 through 4. Referring to FIG. 5, the LED 40 includes an LED chip 41 and a dome-shaped collimator 43 that surrounds the LED chip 41. The collimator 43 collimates incident light from the LED chip 41 to be emitted as Lambertian light.

The dome-shaped collimator 43 may be made of a transparent material with a refractive index matching that of the LED chip 41. The dome-shaped collimator 43 may be near the LED chip 41 without air therebetween. This is for maximization of the emission efficiency of light from the LED chip 41, as is well-known in the art, when the LED chip 41 is not surrounded by the index-matching material, because light is not well emitted from the LED chip 41. Here, FIG. 5 shows an example of the LED 40 and, in particular, a portion corresponding to the collimator 43 of the LED 40, may be formed in various shapes. A main proceeding direction of light emitted from the LED 40 may correspond to a central axis c of the LED chip 41 and the collimator 43.

If the LED 40 is obliquely angled on the side surfaces 30 of the protrusion 20 as described above, the central axis c of the LED 40 is not parallel to the bottom surface 50 but is obliquely angled in an upward direction.

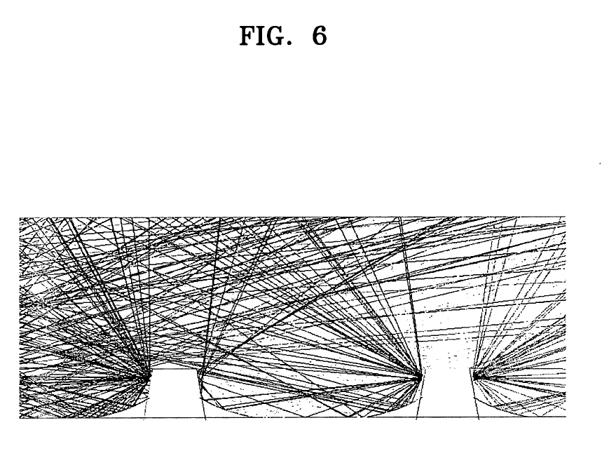

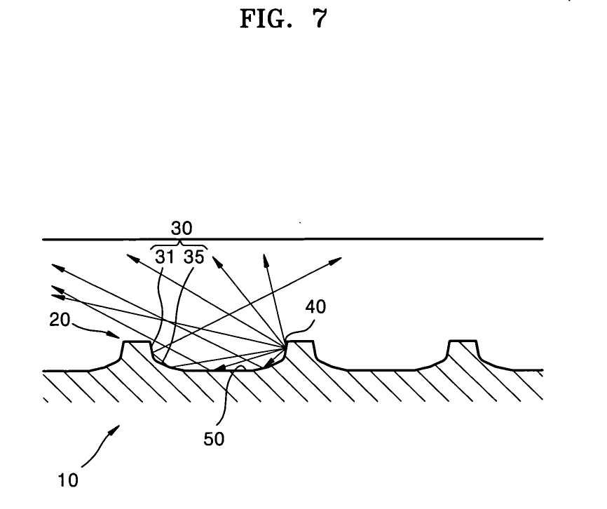

FIG. 6 illustrates ray tracing when the LED 40 is disposed to be obliquely angled on the side surfaces 30 of the protrusion 20, and FIG. 7 illustrates a simplified ray tracing of FIG. 6.

Referring to FIGS. 6 and 7, when the LED 40 is disposed to be obliquely angled on the side surfaces 30 of the protrusion 20, a large portion of light emitted from the LED 40 is obliquely angled in an upward direction, and a portion of the light travels toward the bottom surface 50, and the planar region 31 and the curved region 35 of the side surface 30.

Light incident on the bottom surface 50 is reflected and obliquely travels in an upward direction or is incident on the side surface 30 of the protrusion 20.

A large portion of light from the LED 40 that is directly incident on the curved region 35 of the side surface 30 and a large portion of light reflected from the bottom surface 50 and incident on the curved region 35 is reflected and then incident on the planar region 31 of the side surface 30.

In the planar region 31 of the side surface 30, light is directly incident from the LEDs 40 or incident after being reflected from the bottom surface 50 and the curved region 35 of the side surface 30. Incident light on the planar region 31 is reflected, and then travels mainly in an upward direction.

The LEDs 40 are disposed to be obliquely angled in an upward direction on the side surface 30 of the protrusion 20 so that light emitted from the LEDs 40 is mixed and travels in an upward direction as described above. In this case, because a portion of the side surface 30 adjacent to the bottom surface 50 is formed as the curved region 35, a large portion of the light incident on the curved region 35 is reflected toward the planar region 31 of the side surface 30 so that the light can mix more smoothly.

Accordingly, when the LEDs 40 are disposed to be obliquely angled on the side surface 30 of the protrusion 20 in an upward direction and a portion of the side surface 30 adjacent to the bottom surface 50 is formed as the curved region 35, the light is more smoothly mixed such that a mixing distance required for obtaining a uniform distribution of light can be smaller than in a structure which the planar region 31 of the side surface 30 extends to the bottom surface 50. Thus, when the light emitting panel 10 is used in a backlight system, the reduced mixing distance can contribute to providing a backlight system having a sufficiently small thickness.

In the light emitting panel 10, lines of the LEDs 40 disposed along the lengthwise direction of the protrusion 20 and the side surfaces 30 of the protrusions 20 may be disposed at a predetermined angle with respect to a horizontal direction perpendicular to a direction of gravity, for example, perpendicular to the horizontal direction, as shown in FIG. 2.

The horizontal width of the backlight system having the light emitting panel 10 according to an exemplary embodiment of the present invention can be larger than the vertical width in consideration of an aspect ratio of 4:3 or 16:9 used in a general display device. When the light emitting panel 10 is used in a backlight system for a display device having a larger vertical width than a horizontal width thereof, various combinations of horizontal and vertical widths can be used.

In direct light emitting type backlight systems using LEDs as point light sources, a plurality of LEDs are arranged in a two-dimensional array to form a plurality of lines. A large amount of heat is generated from the LEDs. When the temperature of the LEDs rises due to the heat, the amount of light emitted from the LEDs and emission light wavelength varies so that brightness and color coordinates of the backlight system vary.

Thus, a radiant heat device is used in the backlight system to radiate heat generated in a heat source such as an LED. In general, a heat sink, a fan, and a heat pipe are respectively installed for each row formed by the LEDs in a horizontal direction.

In the general direct light emitting type backlight system, the LEDs arranged in a row are disposed to be parallel to the horizontal direction. Thus, the heat pipe is also installed in the horizontal direction.

However, when the heat pipe is installed in the horizontal direction, its performance may be lowered. That is, the heat pipe performs cooling by moving heat through the circulation of a working fluid. However, when the heat pipe is installed in the horizontal direction, the working fluid liquefied in a condensation portion does not move smoothly back to an evaporation portion through a wick, that is, the circulation of the working fluid is not smooth and the heat pipe does not work well.

When heat generated in the heat source such as the LED cannot be effectively dissipated due to the bad performance of the heat pipe, the brightness of the backlight system is lowered, and color coordinates of the backlight system vary.

However, when, the lines of the LEDs 40, as shown in light emitting panel 10 of FIG. 2, are disposed on the side surfaces 30 of the protrusion 20, along the lengthwise direction of the protrusion 20 and at a predetermined angle with respect to the horizontal direction, for example, perpendicular to the horizontal direction, the movement of a material condensed in the heat pipe can be quickened by gravity.

This is because, in order to move the material condensed in the heat pipe by an influence of gravity, the installation direction of the heat pipe should include a perpendicular component acting with gravity and the heat pipe should be installed such that the condensation portion in which the evaporated working fluid is condensed is placed at the top of the heat pipe.

Accordingly, when a plurality of LEDs 40 are disposed at a predetermined angle with respect to the horizontal direction perpendicular to the direction of gravity, for example, perpendicular to the horizontal direction, the movement of the material condensed in the condensation portion of the heat pipe installed along the arranged line of the LEDs 40 can be quickened by the influence of gravity so that heat generated in the heat source, such as the LEDs 40, can be effectively removed. As such, brightness deterioration or a change of color coordinates can be prevented.

The horizontal direction perpendicular to the direction of gravity may correspond to a horizontal scanning direction of a display device, and a direction perpendicular to the horizontal direction corresponds to the direction of gravity or a direction opposite to gravity. The display using the backlight system as an illumination light, for example, an LCD device, is stood up, and the horizontal scanning direction of the LCD device is parallel to or approximately parallel to the ground to form a predetermined acute angle with respect to the ground, and a scanning direction perpendicular to the horizontal scanning direction is a vertical scanning direction.

The uniformity of light distribution for two cases, that is, when the light emitting panel 10 according to an exemplary embodiment of the present invention is used and when conventional side emitting LEDs are disposed to form a plurality of lines, will now be compared.

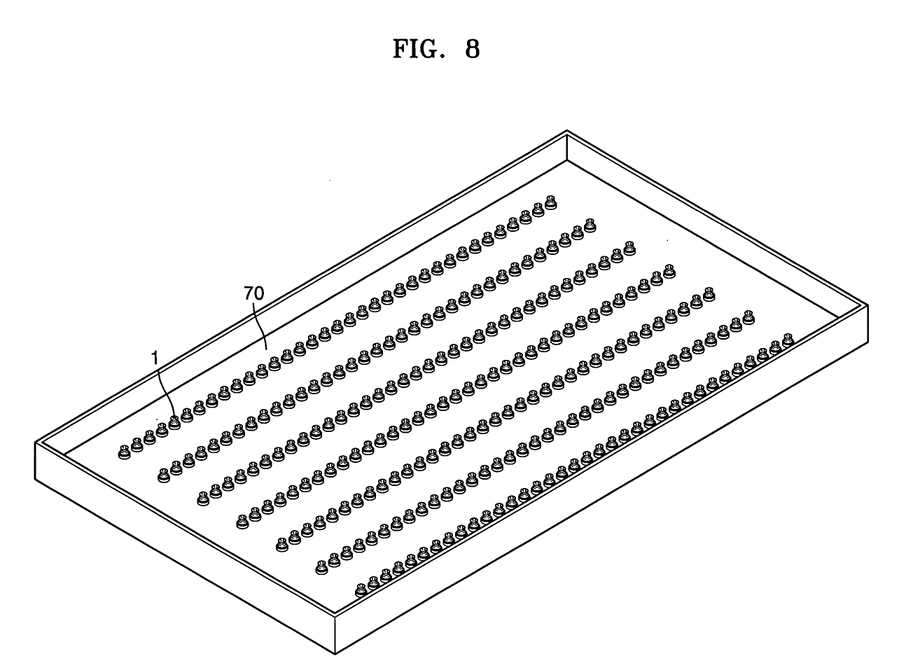

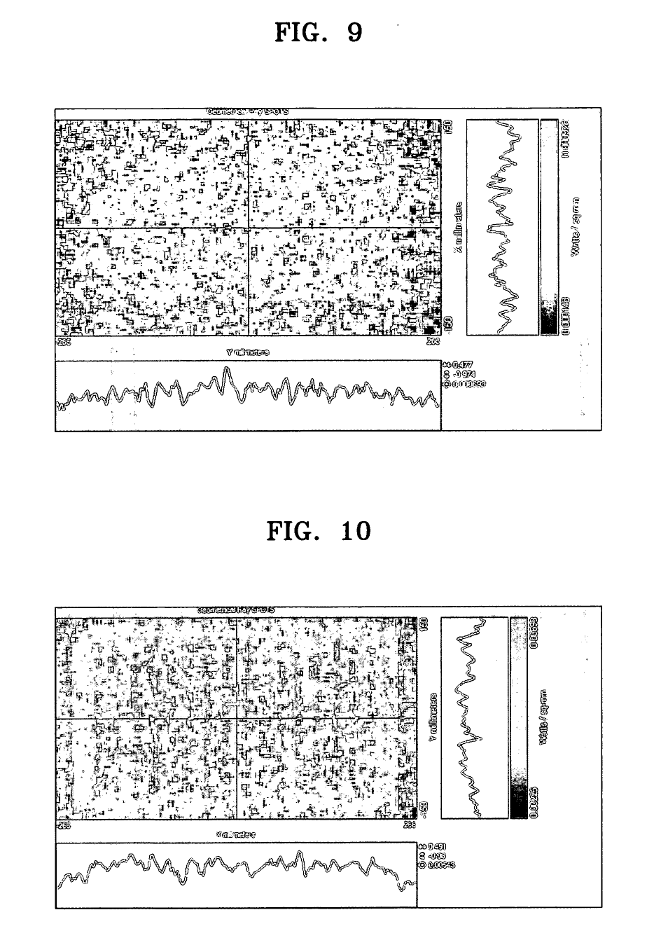

FIG. 8 is a perspective view of an arrangement of conventional side emitting LEDs 1 disposed on a plate 70 to form seven lines. FIG. 9 shows optical simulation result of a distribution of light intensity obtained from the arrangement of FIG. 8. FIG. 10 shows optical simulation results of a distribution of light intensity obtained from the light emitting panel 10 illustrated in FIGS. 2 through 4, 6, and 7.

For comparison, it is assumed that the effective area of the light emitting panel 10 according to an exemplary embodiment of the present invention is the same as the effective area of the plate 70 in which the conventional side emitting LEDs 1 are arranged, and other conditions for measuring the distribution of light intensity, for example, the distance to the detector, are identical.

As known from a comparison of the distributions of light intensity shown in FIGS. 9 and 10, when the light emitting panel 10 according to an exemplary embodiment of the present invention is used, light is more effectively mixed and more uniformly emitted so that a surface light source having a further uniform distribution of light intensity, without dark regions even in corners, can be provided. On the other hand, when the arrangement of the conventional side emitting LEDs 1 is used, dark regions are formed in corners. Thus, it can be understood that the uniformity of distribution of light intensity when the arrangement of the conventional side emitting LEDs 1 is used is lower than when the light emitting panel 10 according to an exemplary embodiment of the present invention is used.

In addition, in the light emitting panel 10 according to an exemplary embodiment of the present invention, because the LEDs 40 can be more densely disposed, a mixing distance of light can be reduced.

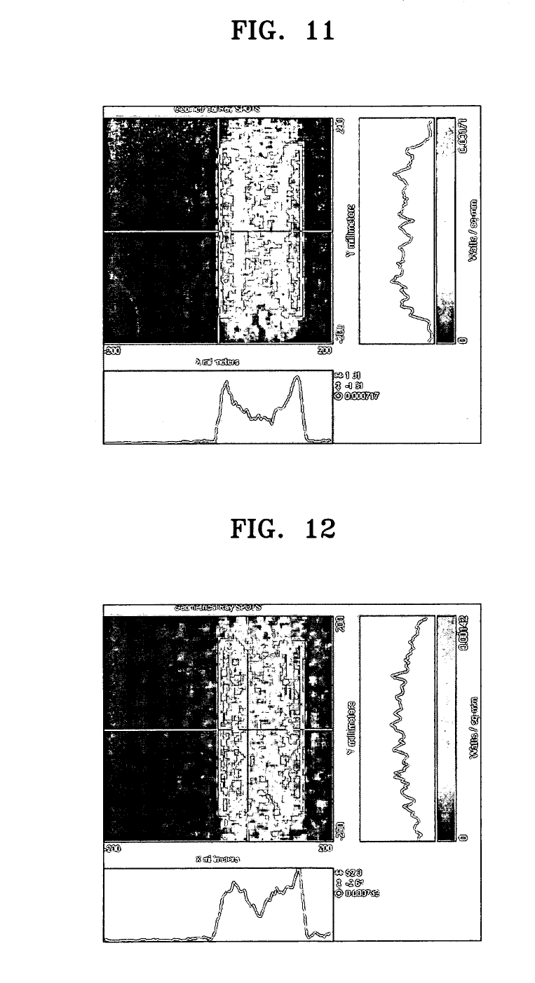

FIG. 11 shows an optical simulation result of a distribution of light intensity when the LEDs 40 are disposed to be obliquely angled on the side surface 30 of the protrusion 20 having a planar region 31 extending to a bottom surface 50, without a curved region. FIG. 12 shows an optical simulation result of distribution of light intensity when the LEDs 40 are disposed to be obliquely angled on the side surface 30 of the protrusion 20 having a planar region 31 and a curved region 35.

It can be understood from the comparison results of FIGS. 11 and 12 that a more uniform distribution of light intensity can be obtained when the curved region 35 exists in the side surface 30 verses when a curved region 35 does not exist in the side surface 30.

In the light emitting panel 10 according to an exemplary embodiment of the present invention, when the curved region 35 is formed on the side surface 30 of the protrusion 20, light can be more smoothly mixed and outputted. Thus, a mixing distance of lights required for obtaining a uniform distribution of light intensity can be further reduced.

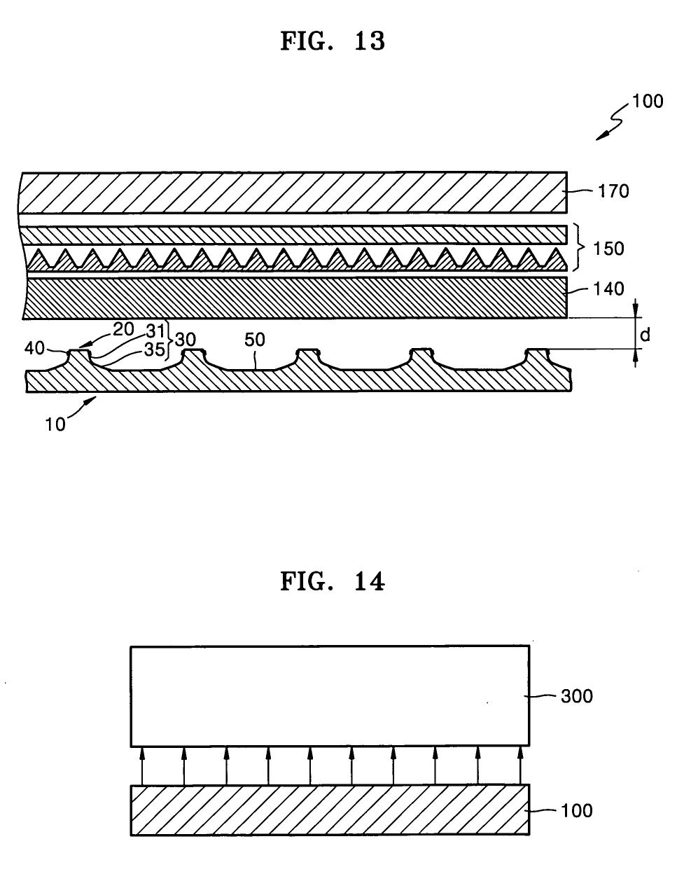

FIG. 13 is a schematic cross-sectional view of a backlight system 100 having a light emitting panel according to an exemplary embodiment of the present invention.

Referring to FIG. 13, the backlight system 100 includes a light emitting panel 10 in which a plurality of the LEDs 40 are arranged, to form a plurality of lines, and a transmission diffusion plate 140 disposed above the light emitting panel 10 to diffuse and transmit incident light.

When using the light emitting panel 10 according to an exemplary embodiment of the present invention, as above described with the comparison of FIGS. 9 and 10, the overall brightness uniformity of the backlight system 100 can be enhanced, and a problem that darkness may occur due to a small amount of light at the edges of the backlight system 100 does not occur.

The brightness uniformity of the backlight system 100 is an important factor in evaluation of a surface light source. In general, brightness at the four edges of the backlight system 100 is lowest, and thus the uniformity of the backlight system 100 is reduced. However, in the light emitting panel 10 according to an exemplary embodiment of the present invention, darkness does not occur in the four edges and thus, the overall brightness uniformity can be enhanced.

When the LEDs emitting different colors of light, such as R, G, B colors of light, are regularly and alternately arranged, or the LEDs 40 are white LEDs, a white light source can be realized.

When the LEDs 40 produce R, G, and B colored light or produce white light, a liquid crystal display (LCD) device having the backlight system 100 according to an exemplary embodiment of the present invention can display color images.

The transmission diffusion plate 140 is disposed a predetermined distance d above the light emitting panel 10. The transmission diffusion plate 140 diffuses and transmits incident light.

When the transmission diffusion plate 140 is too close to the light emitting panel 10, portions of the light emitting panel 10 where the protrusions 20 are disposed may be brighter than other portions of the light emitting panel so that brightness uniformity may be lowered. On the other hand, as the transmission diffusion plate 140 is separated further from the light emitting panel 10, the thickness of the backlight system 100 increases. Thus, the distance d between the transmission diffusion plate 140 and the light emitting panel 10 may be minimized while ensuring that light from the light emitting panel 10 can be smoothly mixed by diffusion. Since the light emitting panel 10 according to an exemplary embodiment of the present invention has an excellent light mixing effect, the distance d between the transmission diffusion plate 140 and the light emitting panel 10 can be greatly reduced.

The backlight system 100 according to an exemplary embodiment of the present invention may further include a brightness enhancement film 150 for enhancing directivity of light emitted from the transmission diffusion plate 140. In addition, the backlight system 100 according to an exemplary embodiment of the present invention may further include a polarization enhancement film 170 for enhancing polarization efficiency.

The brightness enhancement film 150 refracts and condenses light emitted from the transmission diffusion plate 140 to enhance the directivity of light, thereby enhancing brightness.

The polarization enhancement film 170 transmits p-polarized light and reflects s-polarized light so that the emitted light is single polarized light, for example, p-polarized light.

The LCD device having the backlight system 100 according to an exemplary embodiment of the present invention includes a liquid crystal panel on the backlight system 100. The liquid crystal panel allows single linearly-polarized light to be incident on a liquid crystal layer of the liquid crystal panel and changes the direction of a liquid crystal director using an electric field, thereby displaying an image by changing the polarization of light that passes through the liquid crystal layer.

Since light efficiency can be increased when light incident on the liquid crystal panel is singly polarized, when the backlight system 100 is provided with the polarization enhancement film 170 as described above, light efficiency can be enhanced.

When the backlight system 100 is applied to the LCD device, the thickness of the backlight system 100 can be reduced so that the thickness of the LCD device can be further reduced while realizing a high quality image having uniform brightness over the entire screen.

FIG. 14 is a schematic view of a liquid crystal display (LCD) device having the backlight system 100 of FIG. 13. Referring to FIG. 14, the LCD device includes the backlight system 100 and a liquid crystal panel 300 disposed on the backlight system 100. The liquid crystal panel 300 is connected to a driving circuit unit. The detailed configuration of the liquid crystal panel 300 and a display operation performed by circuit driving are well-known in the art, and thus, a detailed description and illustration thereof are omitted.

As described above, in the light emitting panel according to the exemplary embodiments of the present invention, a plurality of LEDs that form lines are sufficiently densely disposed and light generated by the LEDs can be fully mixed and emitted such that a backlight system having a sufficiently small thickness and an LCD device having the backlight system can be provided.

While the present invention has been particularly shown and described with reference to exemplary embodiments thereof, it will be understood by those of ordinary skill in the art that various changes in form and details may be made therein without departing from the spirit and scope of the exemplary embodiments of the present invention as defined by the following claims.

What is claimed is:

1. A light emitting panel comprising:
a bottom surface from which incident light is reflected;
at least one protrusion that has a side surface and protrudes from the bottom surface; and
a plurality of light emitting diodes (LEDs) that are installed in a row on the side surface of the protrusion and obliquely angled with respect to the bottom surface.

2. The light emitting panel of claim 1, wherein the side surface is obliquely angled with respect to the bottom surface.

3. The light emitting panel of claim 2, wherein the protrusion has an additional side surface, such that the side surfaces are opposite each other, and the LEDs are installed on the side surfaces to be obliquely angled with respect to the bottom surface.

4. The light emitting panel of claim 3, wherein the side surfaces are reflective.

5. The light emitting panel of claim 4, wherein the side surfaces respectively comprise a planer region including a portion where the LEDs are arranged, and a curved region adjacent to the bottom surface.

6. The light emitting panel of claim 2, wherein the side surface is reflective.

7. The light emitting panel of claim 6, wherein the side surface comprises a planer region including a portion where the plurality of LEDs are arranged, and a curved region adjacent to the bottom surface.

8. The light emitting panel of claim 1, further comprising a plurality of protrusions to form a plurality of lines, wherein the LEDs are disposed on side surfaces of the plurality of protrusions.

9. The light emitting panel of claim 8, wherein at least one of the side surfaces and the bottom surface is coated for reflection.

10. The light emitting panel of claim 9, wherein the LEDs are disposed on each side surface of the protrusions.

11. A backlight system comprising:
a light emitting panel; and
a first transmission diffusion plate disposed above the light emitting panel which diffuses and transmits incident light from the light emitting panel,
wherein the light emitting panel comprises,
a bottom surface from which incident light is reflected;
at least one protrusion that has a side surface and protrudes from the bottom surface; and
a plurality of light emitting diodes (LEDs) that are installed in a row on the side surface of the protrusion and obliquely angled with respect to the bottom surface.

12. The backlight system of claim 11, wherein the side surface is obliquely angled with respect to the bottom surface.

13. The backlight system of claim 12, wherein the protrusion has an additional side surface, such that the side surfaces are opposite each other, and the LEDs are installed on the side surfaces to be obliquely angled with respect to the bottom surface.

14. The backlight system of claim 13, wherein the side surfaces are reflective.

15. The backlight system of claim 14, wherein the side surfaces respectively comprise a planer region including a portion where the LEDs are arranged, and a curved region adjacent to the bottom surface.

16. The backlight system of claim 12, wherein the side surface is reflective.

17. The backlight system of claim 16, wherein the side surface comprises a planer region including a portion where the plurality of LEDs are arranged, and a curved region adjacent to the bottom surface.

18. The backlight system of claim 11, further comprising a plurality of protrusions to form a plurality of lines, wherein the LEDs are disposed on side surfaces of the plurality of protrusions.

19. The backlight system of claim 18, wherein at least one of the side surfaces and the bottom surface is coated for reflection.

20. The backlight system of claim 19, wherein the LEDs are disposed on each side surface of the protrusions.

21. The backlight system of claim 11, further comprising at least one of a brightness enhancement film which enhances directivity of light emitted from the first transmission diffusion plate and a polarization enhancement film which enhances polarization efficiency.

22. A liquid crystal display (LCD) device comprising:
a liquid crystal panel; and
a backlight system which radiates light onto the liquid crystal panel,
wherein the backlight system comprises,
a light emitting panel comprising,
a bottom surface from which incident light is reflected;
at least one protrusion that has a side surface and protrudes from the bottom surface; and
a plurality of light emitting diodes (LEDs) that are installed in a row on the side surface of the protrusion and obliquely angled with respect to the bottom surface; and
a first transmission diffusion plate disposed above the light emitting panel which diffuses and transmits incident light from the light emitting panel.

23. The LCD device of claim 22, wherein the side surface is obliquely angled with respect to the bottom surface.

24. The LCD device of claim 23, wherein the protrusion has an additional side surface, such that the side surfaces are opposite each other, and the LEDs are installed on the side surfaces to be obliquely angled with respect to the bottom surface.

25. The LCD device of claim 24, wherein the side surfaces are reflective.

26. The LCD device of claim 25, wherein the side surfaces respectively comprise a planer region including a portion where the plurality of LEDs are arranged, and a curved region adjacent to the bottom surface.

27. The LCD device of claim 23, wherein the side surface is reflective.

28. The LCD device of claim 27, wherein the side surface comprises a planer region including a portion where the plurality of LEDs are arranged, and a curved region adjacent to the bottom surface.

29. The LCD device of claim 22, further comprising a plurality of protrusions to form a plurality of lines, wherein the LEDs are disposed on side surfaces of the plurality of protrusions.

30. The LCD device of claim 29, wherein at least one of the side surfaces and the bottom surface is coated for reflection.

31. The LCD device of claim 30, wherein the protrusions respectively have two side surfaces and the LEDs are disposed on both side surfaces of the protrusions.

32. The LCD device of claim 23, wherein the protrusion and the plurality of LEDs make a predetermined angle with respect to a direction perpendicular to the direction of gravity.

33. The LCD device of claim 22, further comprising at least one of a brightness enhancement film which enhances directivity of light emitted from the first transmission diffusion plate and a polarization enhancement film which enhances polarization efficiency.
